(19) United States
(12) Patent Application Publication
(10) Pub. No.: US 2008/0018120 A1
(43) Pub. Date: Jan. 24, 2008

(54) Door Handle Assembly

(76) Inventors: Steve BAILEY, London (CA); John Cunningham, Strathroy (CA)

Correspondence Address: MAGNA INTERNATIONAL, INC., 337 MAGNA DRIVE, AURORA, ON, L4G-7K1, US

(21) Appl. No.: 11/778,830

(22) Filed: Jul. 17, 2007

Related U.S. Application Data
(60) Provisional application No. 60/831,897, filed on Jul. 18, 2006.

(51) Int. Cl. E05B 65/20

(52) U.S. Cl. 292/336.3

(57) ABSTRACT

The invention is a handle assembly for a vehicle door. The handle assembly includes a back plate, operable to be mounted to a portion of the vehicle door, and the back plate including a recessed region displaced away from the exterior surface of the vehicle door. A handle aperture is provided within the recessed region of back plate with at least one pin mount integrally formed within the recessed region of the back plate. The pin mount including a void and a slot that is narrower than the void. A handle is pivotally mounted to the back plate and located at least partially within the recessed region, the handle having at least one integrally-formed pin extending at an angle substantially parallel to the body of the handle; the pin operable to be seated in the aperture to allow pivotal movement of the handle. The handle further includes a spring locator operable to retain a handle spring prior to mounting the handle to the back plate.

This application claims the benefit of U.S. Provisional Application No. 60/831,897 filed Jul. 18, 2006.

### FIELD OF THE INVENTION

The present invention relates to vehicles doors. More specifically, the present invention relates to a handle assembly used to actuate the latch for vehicle doors.

### BACKGROUND OF THE INVENTION

Automotive manufactures are looking to reduce the cost of vehicle components. One way is to reduce costs is to reduce the number of parts used in a component, simplifying both component assembly and supply chain management. Another way is to engineer the component so that it can be assembled more quickly and without expensive equipment. For example, U.S. Pat. No. 6,039,366 to Lewis teaches a handle assembly that includes an escutcheon plate sized to fit in the door aperture; a handle pivotally mounted on the escutcheon plate via an axial pin; a threaded fastener device secured to the escutcheon plate and extending inwardly; and a clip of U-configuration. Once the door handle assembly has been installed in the aperture of the vehicle door skin, the door handle assembly may be mounted simply by tightening the threaded fastener.

U.S. Pat. No. 6,052,948 to Spitzley teaches a method of mounting a motor vehicle door handle assembly on a skin of a door assembly where the handle assembly includes a handle member and a base plate defining a planar surface. A plurality of individual, spaced lug apertures and a separate spaced clip aperture are provided in the door skin. Lugs are provided on the handle base plate, each sized to pass through a respective lug aperture in the door skin to retain the handle assembly on the door skin. The handle includes a depending hook that extends through an aperture in the base plate that is operable to be connected to a cable to actuate a latch.

U.S. Pat. No. 6,059,329 to Spitzley teaches a method of mounting a motor vehicle door handle assembly to a vehicle door consisting of locating a pre-assembled handle assembly within a door skin aperture, and actuating the handle assembly to fixedly mount the handle assembly.

While the above-described patents all describe handle assemblies that can be mounted to a door more quickly, it is still desirable to provide a reduced-cost handle assembly and mounting method.

### SUMMARY OF THE INVENTION

According to the present invention there is provided a handle assembly for a vehicle door, comprising:

a back plate, operable to be mounted to a portion of the vehicle door, the back plate including a recessed region displaced away from an exterior surface of the vehicle door;

a handle aperture within the recessed region of backplate;

at least one pin mount integrally formed within the recessed region of the backplate, the pin mount including a void and a slot that is narrower than the void;

a handle, pivotally mounted to the backplate and located at least partially within the recessed region, the handle having at least one integrally-formed pin extending at an angle substantially parallel to the body of the handle; the pin operable to be seated in the aperture to allow pivotal movement of the handle.

This invention provides a simple handle assembly for a vehicle door, with reduced number of elements that is economical to produced and at the same time does not limit the function.

### BRIEF DESCRIPTION OF THE DRAWINGS

Preferred embodiments of the present invention will now be described, by way of example only, with reference to the attached Figures, wherein:

FIGS. 1A and 1B are exploded views of a handle assembly according to a first aspect of the invention;

FIGS. 2A and 2B are A side-facing and B side-facing perspective views of the handle assembly shown in FIGS. 1A and 1B;

FIG. 3 is an B side-facing perspective view of a portion of a backplate for the handle assembly shown in FIGS. 1A and 1B;

FIG. 4 is an A side-facing perspective view of the handle for the handle assembly shown in FIGS. 1A and 1B;

FIG. 5 is an B side-facing perspective view of the handle shown in FIG. 4; and

FIGS. 6 and 7 are perspective views of the handle mounted to the backplate for the handle assembly shown in FIGS. 1A and 1B.

### DETAILED DESCRIPTION OF THE INVENTION

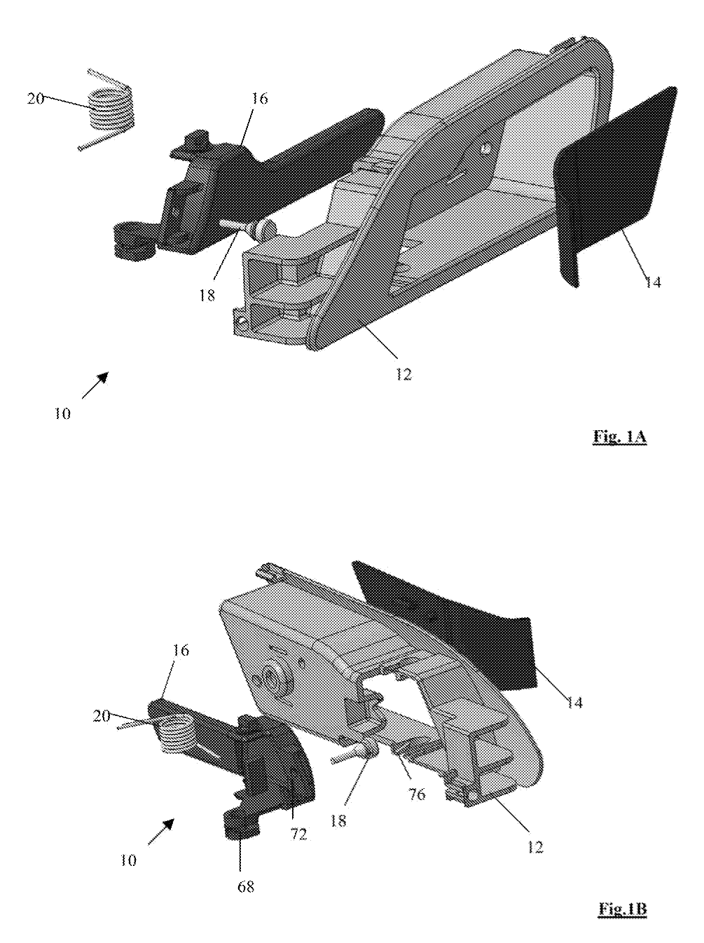

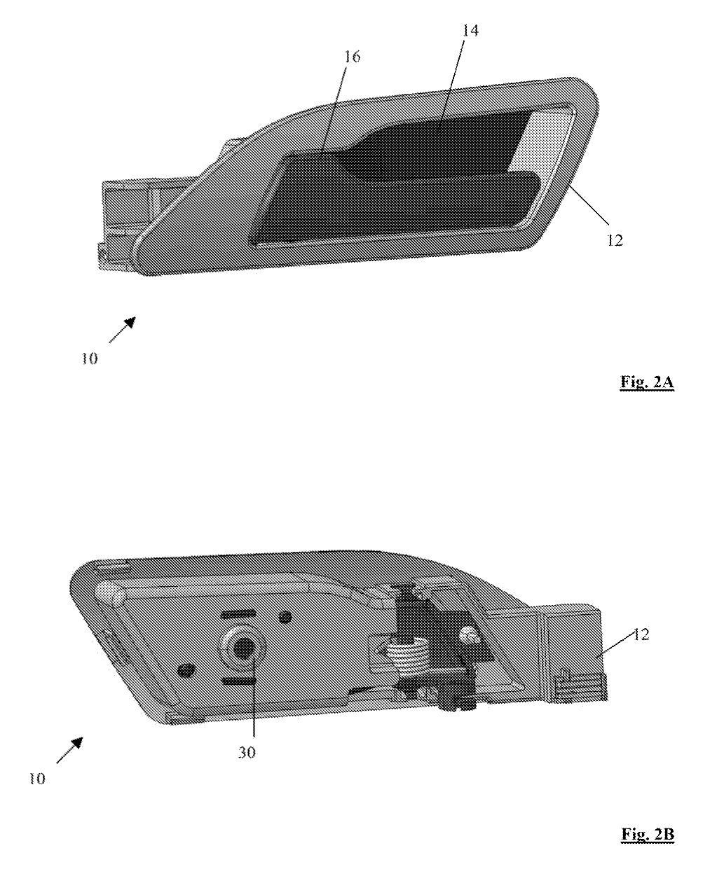

Referring now to FIGS. 1A and 1B, an embodiment of the invention is shown generally at 10. FIG. 1A shows the “A-side”, or exposed side of handle assembly 10, and FIG. 1B shows the “B-side”, or concealed side of handle assembly 10. Handle assembly 10 includes a backplate 12, a cover plate 14, a handle 16, a bumper 18, and a torsion spring 20. During assembly, bumper 18 and torsion spring 20 are pre-mounted to handle 16, which is then pivotally mounted to backplate 12. The mounting of bumper 18 and torsion spring 20 are described in greater detail below. Once assembled (FIGS. 2A and 2B), handle assembly 10 is mountable to an aperture in a vehicle door skin (not shown), and secured to either the door itself or to an internal equipment module (also not shown).

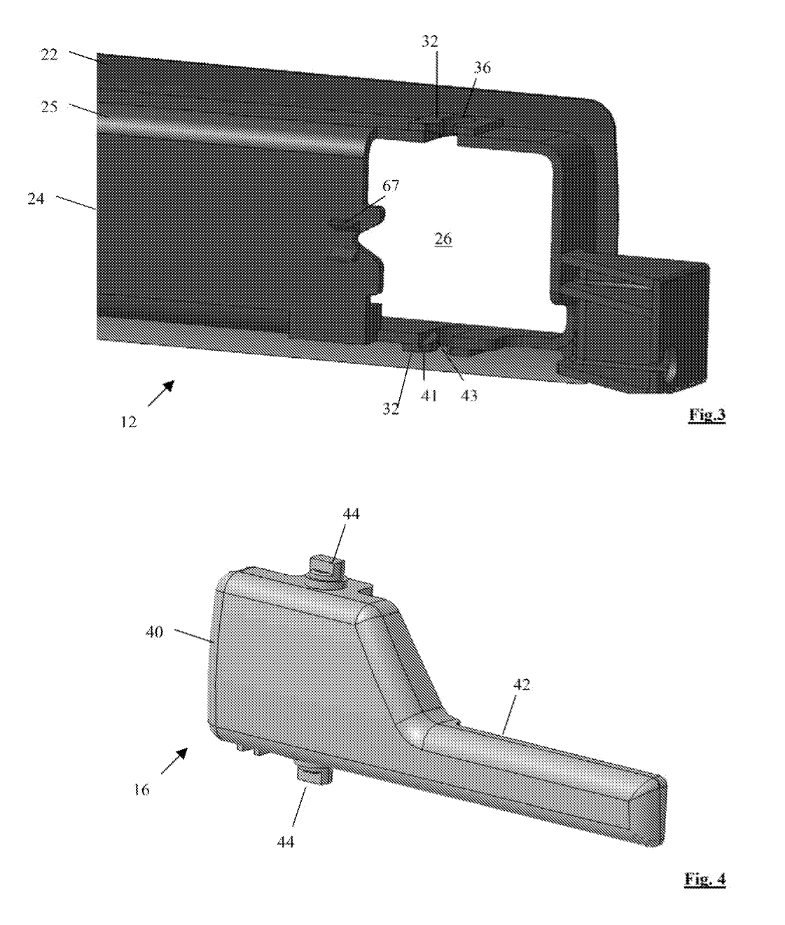

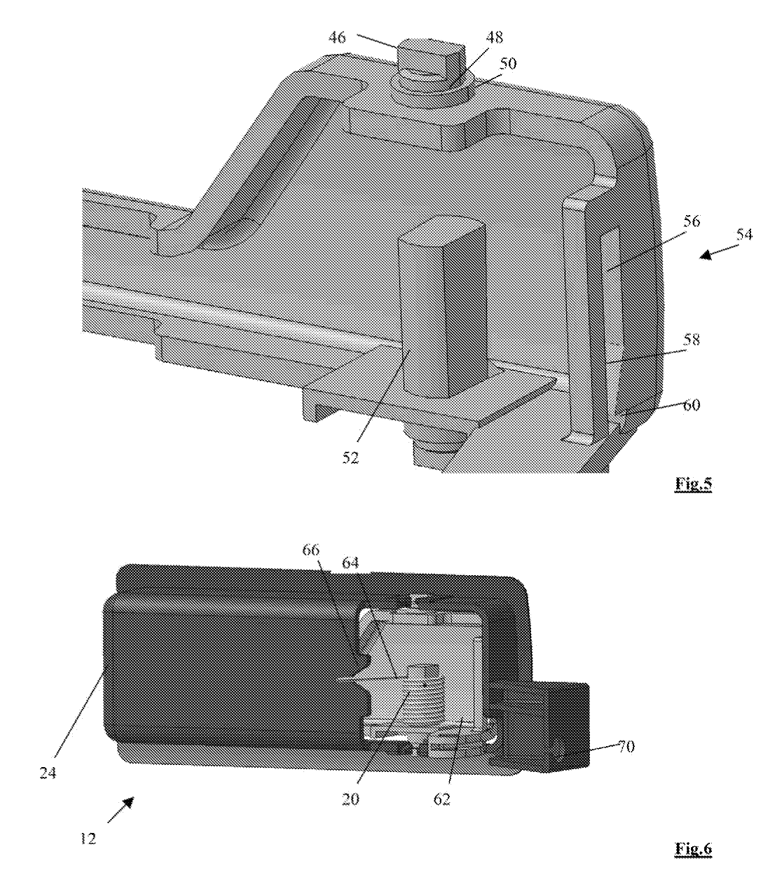

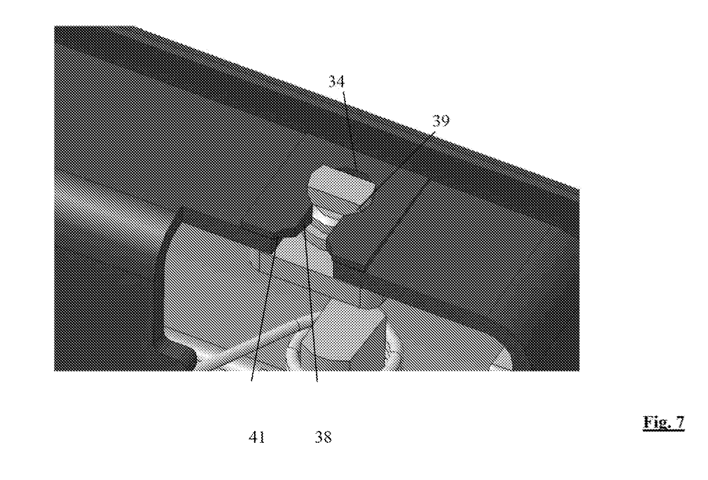

Referring now to FIG. 3, backplate 12 includes a perimeter flange 22 shaped to match the contours of the A side sheet metal or trim panel of the vehicle door skin (not shown), and a concave region 24 that is recessed into the door (relative to the A side). A web portion 25 interconnects perimeter flange 22 and concave region 24. A handle aperture 26 is provided within concave region 24 to insert handle 16 (described in greater detail below). At least one fastener aperture hole 30 (FIG. 2B) is provided within concave region 24 to locate screws or other such fasteners to secure backplate 12 to the vehicle door. Cover plate 14 id fitted as to cover over a portion of concave region 24 and to hide the securing fasteners (FIG. 2A).

Referring now to FIGS. 3 and 7, within web portion 25, on opposite sides of handle aperture 26 is a pair of pivot mounts 32. The two pivot mounts 32 each include a generally cylindrical wall 34 defining a void 36. A slot 38 is provided in web portion 25 interconnecting handle aperture 26 with void 36. A bezel 39 runs along the periphery of cylindrical wall 34. At the mouth of each slot 38 is a curved surface 41 to help locate handle 14 prior to the insertion of the handle into pivot mount 32. Along the sidewalls of slot 38 is a ramp portion 43 to ease the snap-in insertion of handle 14 and to retain the handle after insertion.

Referring now to FIGS. 4 and 5, handle 16 is shown in greater detail. Handle 16 includes an integrally-formed handle body portion 40 and a narrower handle arm portion 42 adapted for grasping. A pair of integrally-formed pins 44 form the pivot axis for handle 16. When handle 16 is inserted into handle aperture 26, pins 44 are guided into pivot mounts 32 Each of pins 44 includes a pair of D-flat portions 46, a cylindrical pivot surface 48 and a bearing surface 50. The D-flat portions 46 are sized to fit within slot 38 when the handle is inserted generally perpendicular into handle aperture 26 and to retain handle 16 when the handle is non-perpendicular relative to backplate 12. Pivot surface 48 interfaces with bezel 39 to allow handle 16 to rotate. Bearing surface 50 interfaces with the bezel 39 to maintain the spacing between the backplate 12 and body portion 40.

Along the B side-facing surface of the handle 16 there is provided a handle spring post 52 and a spring locator 54. Spring locator 54 includes a slot 56 having a ramp portion 58 and a pocket 60. Torsion spring 20 is retained within pocket 60. A second arm 64 on torsion spring 20 abuts against a groove 66 in the concave region 24 of backplate 12. Preferably, a pair of integrally-formed spring locator tabs 67 helps to locate and retain second arm 64 (FIG. 3). During assembly, handle spring post 52 helps locate and support torsion spring 20. After torsion spring 20 is mounted to handle spring post 52, first arm 62 is inserted into slot 56 and pushed along ramp portion 58 to snap into pocket 60, which retains the arm during both assembly and operation of handle assembly 10.

An arm 68 is provided on the B side-facing side of body portion 40 extending inwards. The end of arm 68 is adapted to receive the end of a door cable or cable rod (neither shown) in order to actuate a door latch (also not shown). Preferably a cable guide 70 is provided on the inside of backplate 12 in order to help route the cable or rod. Bumper 18 is seated within a bumper aperture 72 located along an edge of body portion 40. A flared portion 74 of bumper 18 abuts against a ramp 76 integrally formed in backplate 12, and provides a dampening effect when handle 14 returns to the resting position.

During assembly, handle 14 is preloaded with torsion spring 20 and bumper 18 prior to mounting to backplate 12. An assembler locates torsion spring 20 around handle spring post 52. Handle spring post 52 helps to retain the spring during subsequent assembly steps. The handler next places the first arm 62 of the spring into slot 56. By forcing first arm 62 against the incline of ramp portion 58, the arm is loaded so that it snaps into pocket 60. Once located within pocket 60, first arm 72 remains in place for future assembly steps. Preferably, bumper 18 is seated within bumper aperture 72 prior to mounting handle 14 to backplate 12.

Next, the handle 14 is inserted through handle aperture 26 from the B side at an angle substantially perpendicular to cover 12. Pins 44 are aligned adjacent to pivot mounts 32. Pins 44 are placed up against curved surfaces 41 to help locate handle 14. The assembler can now press handle 14 into pivot mounts 32 as the D-flat portions 46 of pins 44 slide through slots 36, and into voids 38 where it snap-locked in place. Ramp portions 43 ease the snap-in insertion of handle 14 and to retain the handle after insertion. As pins 44 move through slots 36, second arm 64 on torsion spring 20 is compressed against groove 66, placing torsion spring 20 under load. Once pins 44 enter voids 38, the assembler releases handle 14, and torsion spring 20 pivots handle 14 into its un-actuated position. During operation, handle 14 is pivoted by an operator between its un actuated and actuated positions. As with assembly, pivoting handle 14 moves into the actuated position, the load on torsion spring 20 increases to prevent the handle from moving fully perpendicular to backplate 12.

Those skilled in the art will understand that a variety of modifications may be made to the embodiments described herein without departing from the spirit of the invention. For example, pivot mounts 34 may include extended and reinforced walls to provide a greater resiliency against the twisting of the handle. Alternatively, handle assembly 10 may be adapted to other types of closures, such as hatched, lift and tail gates, glove compartment boxes or exterior facing door handle assemblies.

What is claimed is:

1. A handle assembly for a vehicle door, comprising:
a back plate, operable to be mounted to a portion of the vehicle door, the back plate including a recessed region displaced away from an exterior surface of the vehicle door;
a handle aperture within the recessed region of backplate;
at least one pin mount integrally formed within the recessed region of the backplate, the pin mount including a void and a slot that is narrower than the void;
a handle, pivotally mounted to the back plate and located at least partially within the recessed region, the handle being movable between a resting position and an actuated position, wherein
the handle having at least one integrally-formed pin extending at an angle substantially parallel to the body of the handle; the pin operable to be seated in the aperture to allow pivotal movement of the handle.

2. The handle assembly of claim 1, wherein the at least one integrally-formed pin includes a flat portion adapted as to be inserted through the slot into the void when the handle is at a first angle relative to the back plate and to retain the handle within the void when the handle is at a second angle relative to the back plate.

3. The handle assembly of claim 3, wherein that at least one pin mount includes a beveled surface on the perimeter of the void and the at least one pin has a complementary surface adapted for pivoting the handle when mounted to the back plate.

4. The handle assembly of claim 1, wherein the at least one integrally-formed pin is a pair of integrally-formed pins on opposing sides of the handle and the at least one pin mount is a pair of pin mounts on opposing edges of the recessed region.

5. The handle assembly of claim 1, further including a spring mounted to the handle, the spring biasing the handle to the resting position.

6. The handle assembly of claim 6, wherein the handle includes an integrally formed post adapted to retain the spring prior to the handle being mounted to the back plate.

7. The handle assembly of claim 6, wherein the handle further includes a locating slot operable to retain an arm on the spring, thereby reducing rotation of the spring prior to the handle being mounted to the back plate.
